(19) United States
(12) Patent Application Publication
(10) Pub. No.: US 2006/0168625 A1
(43) Pub. Date: Jul. 27, 2006

(54) INTELLIGENT RECORDING OF A SCHEDULED PROGRAM

(75) Inventor: John Taylor Gildred, Oakland, CA (US)

Correspondence Address: DVA/PIONEER RESEARCH CENTER USA, INC.;INTELLECTUAL PROPERTY DEPARTMENT, 2355 MAIN STREET, SUITE 200, IRVINE, CA, 92614, US

(73) Assignee: PIONEER RESEARCH CENTER USA, INC., San Jose, CA (US)

(21) Appl. No.: 10/905,886

(22) Filed: Jan. 25, 2005

(51) Int. Cl. H04N 5/445; G06F 3/00; G06F 13/00

(52) U.S. Cl. 725/58

(57) ABSTRACT

One embodiment of the invention is a technique to stop recording a program intelligently. Stopping recording a program is delayed from a scheduled stop recording time. A transition between the program and a commercial is detected after the scheduled stop recording time. Recording the program is stopped at the detected transition. Another embodiment of the invention is a technique to start recording a program intelligently. Starting recording a program is advanced from a scheduled start recording time. A transition between a commercial and the program is detected within a recording window before the scheduled start recording time. Recording the program is started if the transition is detected within the recording window.

### BACKGROUND

1. Field of the Invention

Embodiments of the invention relate to the field of broadcast recording, and more specifically, to recording scheduled programs.

2. Description of Related Art

Modern recording devices allow a user to select a show or program in a program guide to be recorded at a future time. The user typically selects the recording start and end times for a particular broadcast show or program based on the information in the program guide. The recording start and end times are typically entered based on the scheduled start and end times. However, the actual start or end times may be different than the scheduled start and end times due to program length variations, delays in broadcasting, or unexpected events. Setting recording times based on scheduled times may therefore lead to missing program portions.

Existing techniques designed to deal with this problem have a number of drawbacks. One technique is to allow the user to select a padding time period (e.g., one minute, two minutes). This technique is inflexible and may capture undesired commercials.

### BRIEF DESCRIPTION OF THE DRAWINGS

The invention may best be understood by referring to the following description and accompanying drawings that are used to illustrate embodiments of the invention. In the drawings:

FIG. 1A is a block diagram illustrating a computer system in which one embodiment of the invention can be practiced.

FIG. 1B is a diagram illustrating a system in which one embodiment of the invention can be practiced.

FIG. 1C is a diagram illustrating a program recording module according to one embodiment of the invention.

FIG. 2 is a diagram illustrating timings of recording a program according to one embodiment of the invention.

FIG. 3 is a flowchart illustrating a process to stop recording a program according to one embodiment of the invention.

FIG. 4 is a flowchart illustrating a process to start recording a program according to one embodiment of the invention.

FIG. 5 is a diagram illustrating black spot signal according to one embodiment of the invention.

### DESCRIPTION OF THE INVENTION

One embodiment of the invention is a technique to stop the recording of a program intelligently. Stopping recording of a program is delayed from a scheduled stop recording time. When a transition between the program and a commercial is detected after the scheduled stop recording time, recording the program is stopped at the detected transition. Another embodiment of the invention is a technique to start recording a program intelligently. The start of the recording of a program is advanced from a scheduled start recording time. A transition between a commercial and the program is detected within a recording window before the scheduled start recording time. Recording the program is started if the transition is detected within the recording window.

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, software, firmware, microcode, or any combination thereof. When implemented in software, firmware, or microcode, the elements of the embodiment of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the machine accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operation described in the following. The term “data” here refers to any type of information that is encoded for machine-readable purposes. Therefore, it may include program, code, data, file, etc.

All or part of an embodiment of the invention may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

It is noted that an embodiment of the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

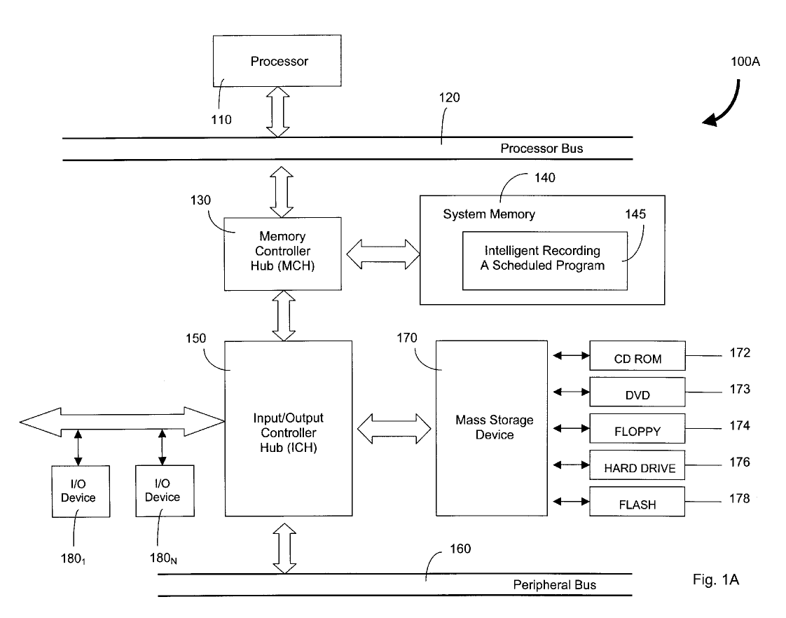

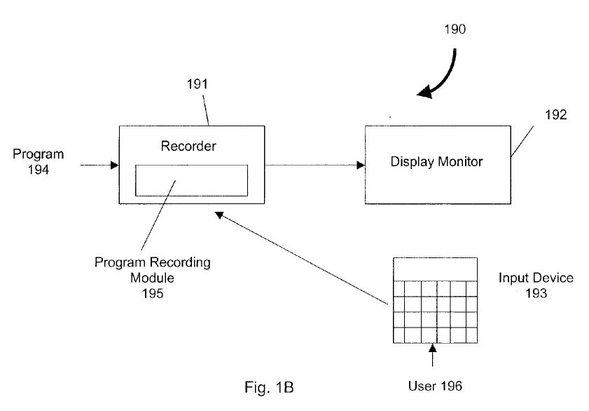

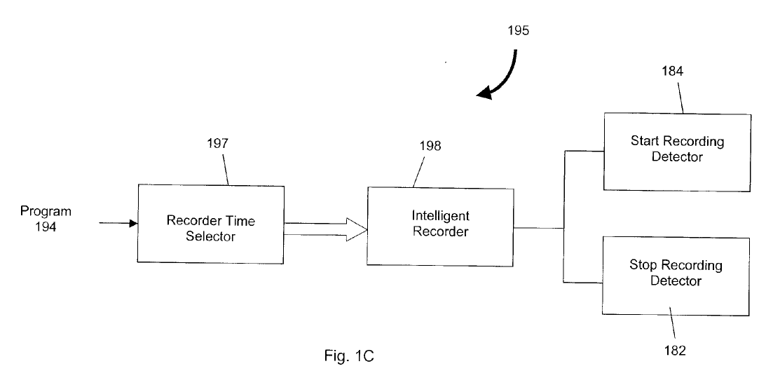

FIG. 1A is a diagram illustrating a processor system 100A in which one embodiment of the invention can be practiced. The processor system 100 includes a processor 110, a processor bus 120, a memory control hub (MCH) 130, a system memory 140, an input/output control hub (ICH) 150, a peripheral bus 160, a mass storage device 170, and input/output devices 180₁ to 180_{N}. Note that the processor system 100 may include more or less elements than these elements.

The processor 110 represents a central processing unit of any type of architecture, such as embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The processor bus 120 provides interface signals to allow the processor 1110 to communicate with other processors or devices, e.g., the MCH 130. The processor bus 120 may support a uni-processor or multiprocessor configuration. The processor bus 120 may be parallel, sequential, pipelined, asynchronous, synchronous, or any combination thereof.

The MCH 130 provides control and configuration of memory and input/output devices, the system memory 140, and the ICH 150. The MCH 130 may be integrated into a chipset that integrates multiple functionalities such as the isolated execution mode, host-to-peripheral bus interface, and memory control. The MCH 130 interfaces to the peripheral bus 160. For clarity, not all the peripheral buses are shown. It is contemplated that the system 140 may also include peripheral buses such as Peripheral Component Interconnect (PCI), accelerated graphics port (AGP), Industry Standard Architecture (ISA) bus, and Universal Serial Bus (USB), etc.

The system memory 140 stores system code (i.e., code to calculate a shared key) and data. The system memory 140 is typically implemented with dynamic random access memory (DRAM) or static random access memory (SRAM). The system memory 140 may include program code or code segments implementing one embodiment of the invention. The system memory includes a user interface management 145 (i.e., intelligent recording of a scheduled program). Any one of the elements of the user interface management 145 may be implemented by hardware, software, firmware, microcode, or any combination thereof. The system memory 140 may also include other programs or data, which are not shown, such as an operating system. The user interface management 145 contains program code that, when executed by the processor 110, causes the processor 110 to perform operations as described below.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface to interface to the peripheral bus 160, processor interface, interrupt controller, direct memory access (DMA) controller, power management logic, timer, system management bus (SMBus), universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, a digital video/versatile disk (DVD) 173, floppy drive 174, hard drive 176, flash memory 178, and any other magnetic or optic storage devices. The mass storage device 170 provides a mechanism to read machine-accessible media. The machine-accessible media may contain computer readable program code to perform tasks as described in the following.

The I/O devices 180₁ to 180_{N} may include any I/O devices to perform I/O functions. Examples of I/O devices 180₁ to 180_{N} include controllers for input devices (e.g., keyboard, mouse, trackball, pointing device), media cards (e.g., audio, video, graphics), network cards, and any other peripheral controllers. Elements of one embodiment of the invention may be implemented by hardware, firmware, software or any combination thereof. The term hardware generally refers to an element having a physical structure such as electronic, electromagnetic, optical, electro-optical, mechanical, electro-mechanical parts, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc. that is implemented or embodied in a hardware structure (e.g., flash memory, ROM, EROM). Examples of firmware may include microcode, writable control store, and micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read-only memory (ROM), a flash memory, an erasable ROM (EROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, causes the machine to perform the operations described in the following. The machine accessible medium may also include program code embedded therein. The program code may include machine-readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, an argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

FIG. 1B is a diagram illustrating a system 190 in which one embodiment of the invention can be practiced. The system 190 includes a recorder 191, a display monitor 192, and an input device 193.

The recorder 191 is a device that records a program 194. It may be an analog recorder, a digital recorder, a video cassette recorder (VCR), a digital versatile/video recorder (DVD). It may be integrated into the display monitor 192 or a computer system. It includes a program recording module 195 to recording programs intelligently. The program 194 may be a broadcast television program, a video/audio program, a cable network program, a digital content delivered over a network (e.g., Internet). The recorder 191 may include a processor to execute program code to carry out the operations described in the following. The program code may be embodied in a machine readable medium such as memory, mass storage device, etc. as described above.

The display monitor 192 is any display device that displays the received program. It may be a television set, an analog or digital display, a flat panel display, a liquid crystal display, a cathode ray tube (CRT), etc. It may be integrated into a computer system.

The input device 193 allows a user 196 to interact with the recorder 191. It may have a keyboard, an infrared transmitter/receiver, a wireless transmitter/receiver, etc. It may be connected to the recorder 191 or the display monitor 192 in a wired or wireless connectivity. The user 196 uses the input device 193 to program recording of the program 194. The recorder 191 provides graphical user interface (GUI) to allow the user to select programs, channels, program schedules, program contents, etc.

FIG. 1C is a diagram illustrating the program recording module 195 according to one embodiment of the invention. The program recording module 195 may be a software function or module that is part of a programming system. It includes a recording time selector 197 and an intelligent recorder 198.

The recording time selector 197 allows the user to select desired recording times of the program 194. The user typically scans a program schedule which shows the broadcast times of programs, episodes, or shows and selects the program 194 to be recorded. The program 194 is typically a program that is broadcast in the future, but it may also be a currently broadcast program. The recording times are typically the start and ending times of the selected program. They may also include padding times or times that are outside the scheduled time. These padding times may include a pre-roll time which is a time period or segment before the start of a program, and a post-roll time which is a time period or segment after the end of a program. The pre-roll and post-roll segments may be a time period of any length (e.g., one minute, two minutes, five minutes, fifteen minutes, thirty minutes).

The intelligent recorder 198 provides an intelligent recording of a program based on a detected transition between a program and a commercial. Before and after the scheduled program broadcasting time, commercials may be aired to advertise products, services, or announcements of program sponsors. The commercial air time may have variations such that the actual start or end time of a scheduled program may be a little different than the scheduled air time in the program guide. In addition, unexpected events or station broadcasting problems may cause delay or early start of the program. Recording the program based on the scheduled times in the program guide therefore may lead to missing a portion of the program actually broadcast.

The intelligent recorder 198 includes a stop recording detector 182 and a start recording detector 184. The stop recording detector 182 detects when the recording should be stopped beyond the scheduled stop recording time. The start recording detector 184 detects when the recording should be started earlier than the scheduled start recording time.

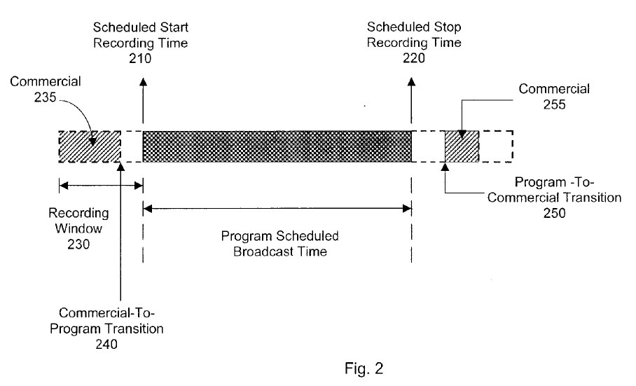

FIG. 2 is a diagram illustrating timings of recording a program according to one embodiment of the invention.

The user selects a scheduled start recording time 210 and a scheduled stop recording time 220. These two recording times define the time interval during the program is to be recorded.

Before the scheduled start recording time 210, there may be a commercial 235. The commercial 235 is aired within a recording window 230. The recording window 230 may be a part of the pre-roll segment, or may be selected to be approximately equal to a standard air time of a commercial (e.g., 30 seconds). The commercial 235 stops at the commercial-to-program transition 240. Since a commercial typically lasts for 30 seconds, if a transition is detected within this time period, it is highly likely that the transition indicates the end of the commercial and the beginning of the program. The actual program starting time is therefore at the transition 240, and not at the scheduled start recording time 210.

After the scheduled stop recording time 220, there may be a commercial 255. The commercial 255 starts at a program-to-commercial transition 250. The actual program termination is therefore at the transition 250 and not at the scheduled stop recording time 220.

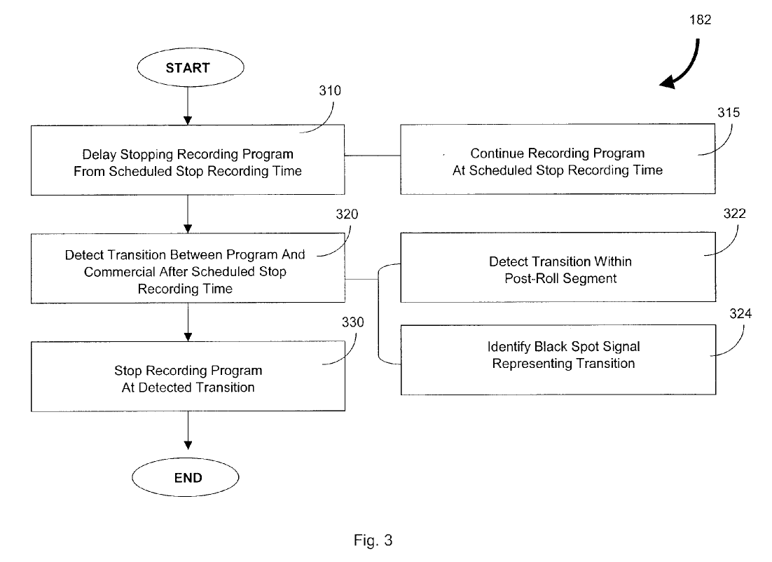

FIG. 3 is a flowchart illustrating a process 182 to stop recording a program according to one embodiment of the invention.

Upon START, the process 182 delays stopping recording the program from the scheduled stop recording time (Block 310). This is performed by continuing the recording of the program past the scheduled stop recording time (Block 315). Then, the process 182 detects a transition between the program and a commercial after the scheduled stop recording time (Block 320). The transition may be detected within a post-roll segment (Block 322).

The process 182 detects the transition by identifying a black spot representing the transition in the broadcast signal (Block 324). The identification of the black spot can be carried out by a number of techniques including analog and digital techniques. Next, the process 182 stops recording the program at the detected transition (Block 330) and is then terminated. In one embodiment, the process 182 stops recording the program at an instant, which is the earlier of the detected transition and the end of the post-roll segment. This is performed in case the user does not want to record the program past the post-roll segment because a recording of another program may immediately be started at the end of the post-roll segment.

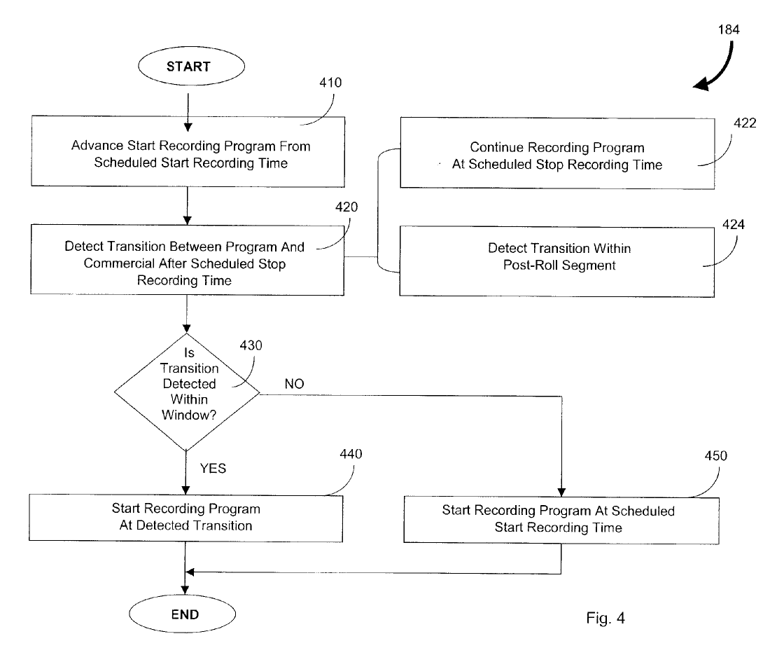

FIG. 4 is a flowchart illustrating a process 184 to start recording a program according to one embodiment of the invention.

Upon START, the process 184 advances starting the recording of the program from the scheduled start recording time (Block 410). This is performed by beginning monitoring the transition within a recording window before the scheduled start recording time. Next, the process 184 detects a transition between a commercial and the program within the recording time before the scheduled start recording time (Block 420). The recording window may be within a pre-roll segment (Block 422). The recording window may also be within a commercial period (Block 424). This commercial period may be within 0 second to 30 seconds.

Then, the process 184 determines if the transition is detected within the recording window (Block 430). If so, the process 184 starts recording the program at the detected transition (Block 440) and is then terminated. Otherwise, the process 184 starts recording the program at the scheduled start recording time (Block 450) and is then terminated.

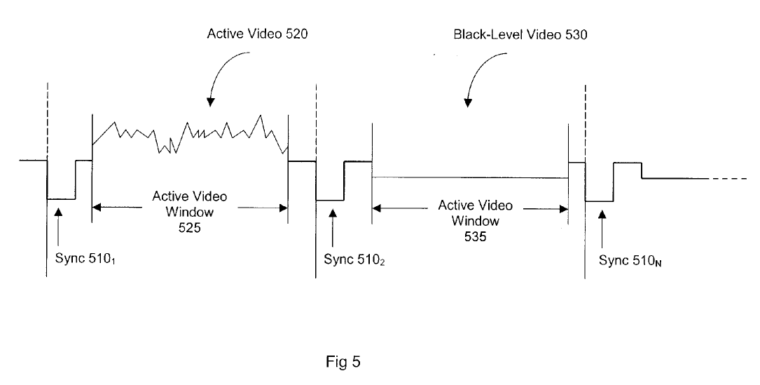

FIG. 5 is a diagram illustrating a black spot signal according to one embodiment of the invention. The broadcast signal includes sync signals 510₁ to 510_{N}, an active video signal 520, and a black level video 530.

The sync signals 510₁ to 510_{N} may be the horizontal sync signals transmitted as part of the video signal in the broadcast program. They are used to mark the beginning of the horizontal lines in the display. The active video signal 520 indicates the normal video signal of the program or the commercial. The black-level video 530 represents the black video information of the black spot. This black-level video 530 may appear for several horizontal lines or vertical frames. It represents the black spot indicating a transition from a program or commercial to a commercial or a program, respectively.

The detection of the transition can be performed by analog methods or digital methods. In the analog methods, an analog comparator may be used to compare the video signal within the active video window (e.g., windows 525, 535) with a predefined threshold close to the black level. The comparator output is then integrated over a predetermined number of horizontal lines. The comparator output represents the amount of the accumulated black level. When this amount exceeds a specified threshold, a transition is detected. The digital methods use image processing techniques to accumulate the number of digitized pixels that are close to the black level. This can be performed on the basis of each horizontal lines or each frame. When this number exceeds a predefined threshold, a transition is detected.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
delaying a stop of recording a program from a scheduled stop recording time;
detecting a transition between the program and a commercial after the scheduled stop recording time; and
stopping the recording of the program at the detected transition.

2. The method of claim 1 wherein delaying comprises:
continuing the recording of the program at the scheduled stop recording time.

3. The method of claim 1 wherein detecting comprises:
detecting the transition within a post-roll segment.

4. The method of claim 1 wherein detecting comprises:
identifying a black spot signal representing the transition.

5. The method of claim 1 wherein the program is a broadcast program.

6. A method comprising:
advancing a start of recording a program from a scheduled start recording time;
detecting a transition between a commercial and the program within a recording window before the scheduled start of recording time; and
starting recording the program if the transition is detected within the recording window.

7. The method of claim 1 wherein the recording window is within a pre-roll segment.

8. The method of claim 1 wherein the recording window is within a commercial period.

9. The method of claim 6 further comprising:
starting the recording of the program at the scheduled start recording time if the transition is not detected within the recording window.

10. The method of claim 6 wherein the program is a broadcast program.

11. An article of manufacture comprising:
a machine-accessible medium including data that, when accessed by a machine, causes the machine to perform operations comprising:
delaying a stop of recording a program from a scheduled stop recording time;
detecting a transition between the program and a commercial after the scheduled stop recording time; and
stopping the recording of the program at the detected transition.

12. The article of manufacture of claim 11 wherein the data causing the machine to perform delaying comprises data that, when accessed by the machine, causes the machine to perform operations comprising:
continuing the recording of the program at the scheduled stop recording time.

13. The article of manufacture of claim 11 wherein the data causing the machine to perform detecting comprises data that, when accessed by the machine, causes the machine to perform operations comprising:
detecting the transition within a post-roll segment.

14. The article of manufacture of claim 11 wherein the data causing the machine to perform detecting comprises data that, when accessed by the machine, causes the machine to perform operations comprising:
identifying a black spot signal representing the transition.

15. The article of manufacture of claim 111 wherein the program is a broadcast program.

16. An article of manufacture comprising:
a machine-accessible medium including data that, when accessed by a machine, causes the machine to perform operations comprising:
advancing a start of recording a program from a scheduled start recording time;
detecting a transition between a commercial and the program within a recording window before the scheduled start of recording time; and
starting the recording of the program if the transition is detected within the recording window.

17. The article of manufacture of claim 11 wherein the recording window is within a pre-roll segment.

18. The article of manufacture of claim 11 wherein the recording window is within a commercial period.

19. The article of manufacture of claim 16 the data further comprising data that, when accessed by the machine, causes the machine to perform operations comprising:
starting the recording of the program at the scheduled start recording time if the transition is not detected within the recording window.

20. The article of manufacture of claim 1 wherein the program is a broadcast program.

21. A program recording module comprising:
a first module to allow a user to select desired recording times of a program; and
a stop recording detector coupled to the first module, the stop recording detector comprising:
a module to delay a stop of recording a program from a scheduled stop recording time,
a module to detect a transition between the program and a commercial after the scheduled stop of recording time, and
a module to stop recording the program at the detected transition.

22. The program recording module of claim 21 wherein the module to delay comprises:
a module to continue recording the program at the scheduled stop recording time.

23. The program recording module of claim 21 wherein the module to detect comprises:
a module to detecting the transition within a post-roll segment.

24. The program recording module of claim 21 wherein the module to detect comprises:
a module to identify a black spot signal representing the transition.

25. The program recording module of claim 21 wherein the program is a broadcast program.

26. A program recording module comprising:
a first module to allow a user to select desired recording times of a program; and
a start recording detector coupled to the first module, the start recording detector comprising:
a module to advance a start of recording a program from a scheduled start recording time,
a module to detect a transition between a commercial and the program within a recording window before the scheduled start recording time, and
a module to start recording the program if the transition is detected within the recording window.

27. The program recording module of claim 21 wherein the recording window is within a pre-roll segment.

28. The program recording module of claim 21 wherein the recording window is within a commercial period.

29. The program recording module of claim 26 wherein the start recording detector further comprises:
a module to start recording the program at the scheduled start recording time if the transition is not detected within the recording window.

30. The program recording module of claim 1 wherein the program is a broadcast program.
